(19) United States
(12) Patent Application Publication
(10) Pub. No.: US 2004/0061262 A1
(43) Pub. Date: Apr. 1, 2004

(54) Instrument panel skin for covering airbag and method of making same

(76) Inventor: Glenn Cowelchuk, Chesterfield, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/260,753

(22) Filed: Sep. 30, 2002

(51) Int. Cl. B29C 37/00

(52) U.S. Cl. 264/442; 264/138

(57) ABSTRACT

A method for producing a trim panel for an airbag support assembly comprising the steps of forming a spray aromatic urethane skin and forming a tear seam in the skin by scoring the skin with an ultrasonic knife.

### BACKGROUND OF THE INVENTION

This invention relates generally to motor vehicle passenger restraint systems and more particularly to a seamless trim panel for a motor vehicle airbag support assembly and a method of making the same.

The incorporation of airbags into motor vehicles has resulted in many design challenges for vehicle designers. It is desirable to incorporate an airbag into a motor vehicle trim panel, such as the instrument panel in the front passenger compartment of the vehicle. When incorporating an airbag into the trim panel, it is necessary to provide an airbag cover that will reliably and safely tear during a collision. To this end, a tear seam has generally been provided in the trim panel cover to insure that the airbag safely deploys.

Vehicle designers prefer to have a continuous surface on the front face of the trim panel whenever possible, so the designers would prefer to avoid having a tear seam in the trim panel that is visible to the vehicle passengers. Thus, recently there has been an effort to achieve a “seamless” design, wherein there is no visible indication on the front face of the trim panel that an airbag is located behind the trim panel. To achieve this design, tear seams provided in the trim panel are only provided on the under face, and not on the front face, of the trim panel.

A major design challenge with such “seamless” designs has been to provide a cover for the trim panel that has a tear seam that is not visible on its front face. A conventional cover has a relatively soft skin with a tear seam on its under face. The presence of the tear seam is often visible in the form of a protrusion on a front face of the soft skin due to its soft, pliable nature. A harder skin may be employed, however, providing a tear seam in a harder skin has proven to be difficult because harder skins interfere with the deployment of the airbag.

It is desirable to create a cover for the trim panel that has a skin that is sufficiently hard to prevent a visible sign of a tear seam on its front surface while not interfering with the deployment of the airbag. Preferably, such a cover would have a greater tensile strength, a greater tear strength, and greater elongation than covers currently used. Such a cover also would be easier and more cost effective to produce.

### SUMMARY OF THE INVENTION

In a disclosed embodiment of this invention, an airbag support assembly includes a trim panel cover that includes a spray aromatic urethane skin having a tear seam in its under face, wherein the tear seam is formed with an ultrasonic knife. The invention is also directed to a method for producing a trim panel for an airbag support assembly comprising the steps of forming a spray aromatic skin and scoring the skin with an ultrasonic knife.

These and other features and advantages of this invention will become more apparent to those skilled in the art from the following detailed description of the presently preferred embodiment. The drawings that accompany the detailed description can be described as follows.

### BRIEF DESCRIPTION OF THE DRAWINGS

FIG. 1 is a front view of an instrument panel having an airbag assembly designed according to the present invention.

FIG. 2 is a cross-sectional view along line 2-2 of FIG. 1.

FIG. 3 is a perspective view of the skin on a fixture and a mechanical arm supporting an ultrasonic knife for scoring the skin to make a tear seam therein.

FIG. 4 is an enlarged cross-sectional view of a skin with a tear seam therein.

### DETAILED DESCRIPTION OF THE PREFERRED EMBODIMENT

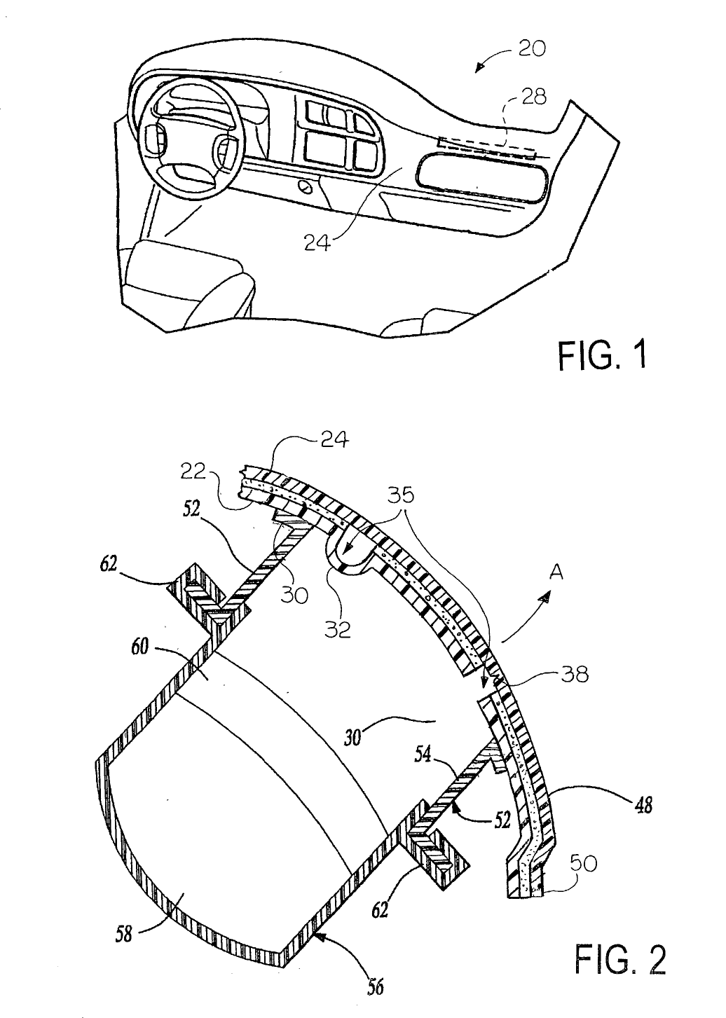

An embodiment of a vehicle instrument panel according to the present invention is shown generally at 20 in FIG. 1. The vehicle instrument panel 20 has a skin or shell 24. Shown in phantom line is an airbag support assembly 28 located behind the skin 24. Although the airbag support assembly 28 in the illustrated embodiment is located behind the skin 24 of the instrument panel 20, it can be located behind any other trim panel that is positioned in the passenger compartment of the vehicle.

As illustrated in FIG. 2, the instrument panel 20 preferably includes a substrate or support 22, which may be in the form of a structural plastic material, such as acrylonitrile-butadiene styrene (ABS)/polycarbonate, thermoplastic poly-olefin (TPO), polypropylene, polyphylene oxide (PPO)/high-impact polystyrene (HIPS), or styrene malaeic anhydrid (SMA). The substrate 22 has an opening formed therein through which an airbag may be deployed. The opening is closed by a door flap 32. The door flap 32 is preferably in the form of plastic, aluminum, or other suitable lightweight material. An outer surface of the substrate 22 and the door flap 32 are preferably bonded to a layer of a suitable energy absorbing elastomeric foam, such as urethane foam, that forms a cushion 50 in an underlying relationship to the skin 24. The skin 24 forms an outer decorative surface for the instrument panel 20.

The door flap 32 has a plurality of outer edges and the opening has a plurality of sides. A flexible hinge member 36 connects one of the outer edges of the door flap 32 to one of the sides of the opening. The hinge member 36 is contiguous along substantially the entire length of one of the outer edges of the door flap 32. As should be appreciated by one of ordinary skill in the art, the hinge member 36 can be in the form of multiple hinges spaced along an outer edge of the door flap 32. Alternatively, the hinge member 36 can be in the form of a single hinge that extends along an outer edge of the door flap 32. The hinge member 36 may be any suitable shape or configuration.

In the illustrated embodiment, the outer edges of the door flap 32 are spaced inwardly from the sides of the opening, although such is not necessary. This spacing creates a gap 35 between the sides of the opening and the outer edges of the door flap 32. The gap 35 or the edge of the door closely overlies the tear seam 38 on an under surface of the skin 24.

The airbag support assembly 28 in the illustrated embodiment is supported beneath the door flap 32 by a welded joint between an outer rim 30 of the airbag support assembly 28 and an under face of the substrate 22. A support structure 52 extends rearward from the outer rim 30. The support structure 52 includes a pair of L-shaped brackets 54. An airbag module 56 includes a pair of channels 62. The channels 62 are shaped to slidably mate with a portion of the L-shaped brackets 54.

The airbag module 56 contains the airbag 60 and an airbag inflator 58 for inflating the airbag 60. The airbag module 56, the airbag 60, and the airbag inflator 58 are all located behind the door flap 32. The airbag module 56, the airbag 60, and the airbag inflator 58 are shown schematically for illustration purposes since such modules are well known in the art and their construction forms no part of this invention. It should be appreciated by one of ordinary skill in the art that the shape of the airbag module 56, the airbag 60, and the airbag inflator 58 may vary from that shown.

During a collision, when the airbag 60 deploys, it will initially be forced against an underside of the door flap 32. The airbag 60 then ruptures the skin 24 along the tear seam 38 so that the portion of the skin 24 within the outlines of the tear seam 38 separates from the rest of the skin 24 and moves with the door flap 32. The flexible hinge member 36 permits the door flap 32 to rotate outwardly (in the direction of arrow A when viewing FIG. 2) so that the airbag 60 can be released into the passenger compartment. During and after deployment of the airbag 60, the weld joint maintains contact between the under face of the substrate 22 and the outer rim 30 of the airbag support assembly 28. In the illustrated embodiment, the outer rim 30 surrounds the door flap 32 and the tear seam 38. Thus, the outer rim 30 is supported around the entire opening in the substrate 22, around the tear seam 38, and around the door flap 32.

In accordance with the present invention, the skin 24 is a spray aromatic urethane skin. The skin 24 is formed from two-components, which, when mixed together, produce a chemical reaction. The mixture is forced through a tube (not shown) and further through a nozzle (not shown) at the end of the tube to produce various spray patterns. The mixture is deposited on a heated tool where it solidifies after a brief period of time (e.g., 45 seconds) to form the skin 24. The skin 24 according to the present invention has a greater tensile strength, a greater tear strength, and a greater elongation than skins currently in use. The skin 24 according to the invention is also harder and thus does not permit visible signs of the tear seam 38 to appear on the front face thereof. Moreover, the skin 24 is easier and more cost effective to produce.

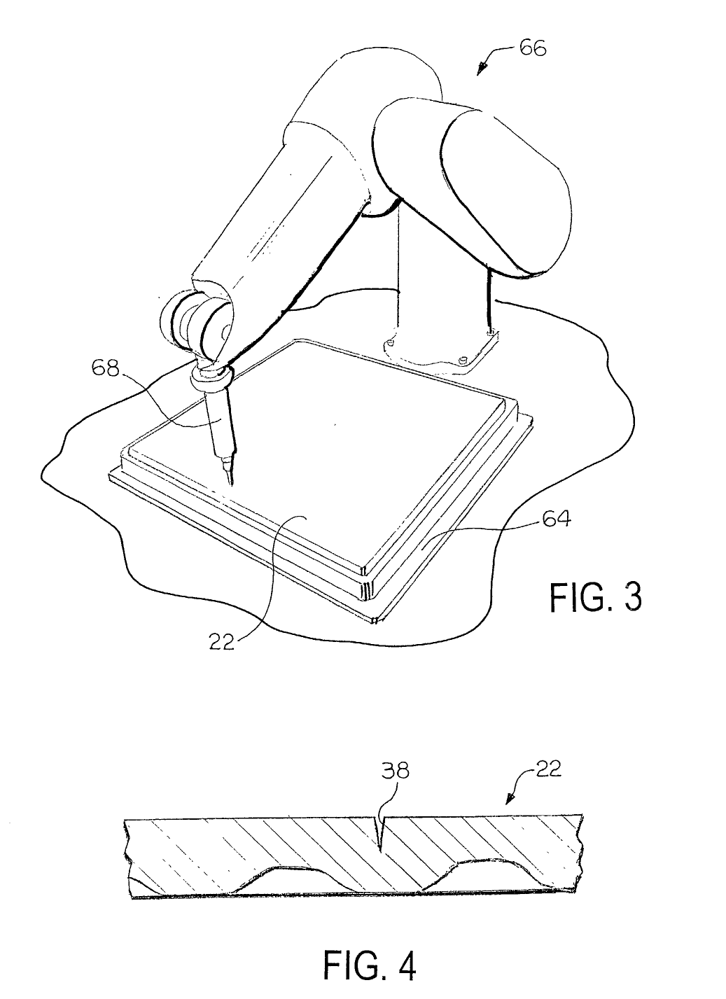

As illustrated in FIG. 3, the skin 24 is placed on a fixture 64 with the front face of the skin 24 tightly against the fixture 64. This can be accomplished in any suitable manner. A mechanical or robotic arm 66 is located next to the fixture 64. The mechanical arm 66 supports an ultrasonic knife 68. Mechanical arms and ultrasonic knives are well known in the art and their construction forms no part of this invention. The ultrasonic knife 68 is guided by the mechanical arm 66 along the skin 24 to score the skin 24 to form the tear seam 38. This weakens the skin 24 in a localized area.

The ultrasonic knife 68 preferably modulates or vibrates at about 20,000 cycles per second to about 100,000 cycles per second. The ultrasonic knife 68 makes a very clean V-shaped tear seam, as illustrated at 38 in FIG. 4. The tear seam 38 may be a continuous tear seam, or a discontinuous tear seam. The mechanical arm 66 precisely controls the distance between the surface of the fixture 64 and the tip of the blade of the ultrasonic knife 68 so that the material of the skin 24 remaining between the tear seam 38 and the front face of the skin 24 remains substantially constant. This is important because the thickness of the skin 24 may vary. Consequently, the depth of the tear seam 38 varies according to variations in the depth of the skin 24. In a preferred embodiment of the invention, the skin 24 is about 0.8 mm to about 1.3 mm and the material remaining between the tear seam 38 and the front face of the skin 24 is in a range of about 0.1 mm and about 0.9 mm. In such case, the skin 24 is sufficiently hard and thick to conceal the tear seam 38 on the front face of the skin 24 but the tear seam 38 sufficiently weakens the skin 24 to allow the airbag 60 to be deployed without interference.

The foregoing description is exemplary rather than limiting in nature. Variations and modifications to the disclosed embodiment may become apparent to those skilled in the art and do come within the scope of this invention. Accordingly, the scope of legal protection afforded this invention can only be determined by studying the following claims.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method for forming a cover for an airbag in a trim panel of a vehicle, the method comprising the steps of:
a) providing a spray aromatic urethane skin; and
b) scoring the spray aromatic urethane skin with an ultrasonic knife to form a tear seam in the skin.

2. The method according to claim 1, wherein the skin providing step comprises the steps of:
a) providing an aromatic urethane mixture;
b) spraying the mixture on a heated tool; and
c) allowing the mixture to solidify to form a skin.

3. The method according to claim 2, wherein the mixture providing step comprises the step of mixing two-components together to cause a chemical reaction therebetween.

4. The method according to claim 2, wherein the spraying step comprises the step of forcing the aromatic urethane mixture through a nozzle at the end of the tube.

5. The method according to claim 2, wherein the step of allowing the mixture to solidify comprises the step of allowing the mixture to remain deposited on the heated tool for about 45 seconds.

6. The method according to claim 1, wherein the scoring step comprises the steps of:
a) placing the skin on a fixture; and
b) guiding the ultrasonic knife with a mechanical arm to score the skin.

7. The method according to claim 6, wherein the placing step comprises the step of placing a front face of the skin tightly against the fixture.

8. The method according to claim 1, wherein the ultrasonic knife is modulated at about 20,000 cycles per second to about 100,000 cycles per second.

9. The method according to claim 1, wherein the tear seam is a continuous V-shaped tear seam.

10. The method according to claim 1, wherein a distance between a surface of the fixture and a tip of the knife blade is controlled by the mechanical arm so that the material remaining between the surface of the fixture and the tip of the knife blade remains substantially constant.

11. The method according to claim 1, wherein the skin is about 1 mm thick and the distance between the surface of the fixture and the tip of the knife blade is in a range of about 0.1 mm and about 0.9 mm.
